(19) United States
(12) Patent Application Publication
(10) Pub. No.: US 2012/0255324 A1
(43) Pub. Date: Oct. 11, 2012

(54) HYDRATABLE TEMPERATURE CONTROL PRODUCT HAVING AN APERTURED OUTER LAYER

(76) Inventor: THOMAS BELINA, Daphne, AL (US)

(21) Appl. No.: 13/310,277

(22) Filed: Dec. 2, 2011

Related U.S. Application Data
(63) Continuation of application No. 61/425,012, filed on Dec. 20, 2010.

(51) Int. Cl. F25D 3/00; B32B 37/00

(52) U.S. Cl. 62/530; 156/60

(57) ABSTRACT

An apparatus for providing temperature control includes a bottom layer, an upper layer permeable to liquid, a hydratable absorbent material positioned between the bottom layer and the upper layer, and an outer layer positioned over the upper layer, the outer layer including one or more apertures for passing a liquid from an exterior surface of the outer layer to the upper layer.

### CROSS REFERENCE TO RELATED APPLICATIONS

This application claims the priority of U.S. Provisional Patent Application Ser. No. 61/425,012, filed Dec. 20, 2010, which is herein incorporated by reference in its entirety.

### FIELD OF DISCLOSURE

The present disclosure relates to temperature control products, and more specifically, to a hydratable temperature control product having an apertured outer layer.

### BACKGROUND

Hydratable temperature control products have been disclosed in the past including a series of spaced, hydratable packets. The packets each include a highly absorbent material (e.g., a superabsorbent polymeric material of a multiply-cross-linked polymer) which absorbs water when the packets are hydrated, creating a hydrated polymer in each of the packets. Once hydrated, the packets can be frozen or heated and used to keep goods cool or hot for a period of time. The packets can be formed from a backing sheet made from an impervious plastic sheet material (e.g., a polyester film), an upper, porous sheet material permeable to water (e.g., a non-woven polypropylene sheet), and a tacky sealant (e.g., ethylene-methyl-acrylate) used to affix and seal the backing sheet to the upper porous sheet, thereby forming the packets. The highly absorbent material is positioned between the backing sheet and the porous upper sheet, and absorbs water through the permeable upper sheet when the packets are hydrated.

### SUMMARY

In one embodiment, an apparatus for providing temperature control includes a bottom layer, an upper layer permeable to liquid and a hydratable absorbent material positioned between the bottom layer and the upper layer. In one embodiment, the apparatus further includes a first outer layer positioned over the upper layer. The first outer layer may include one or more apertures for passing a liquid from an exterior surface of the first outer layer to the upper layer.

In another embodiment, a method for manufacturing a temperature control product having a bottom layer, an upper layer permeable to liquid, a hydratable absorbent material and a first apertured outer layer, comprises the steps of positioning the hydratable absorbent material between the bottom layer and the upper layer, affixing the upper layer to the bottom layer, and affixing the first apertured outer layer over the upper layer. In one embodiment, the first apertured outer layer includes one or more apertures for passing a liquid from an exterior surface of the first apertured outer layer to the upper layer, which in turn allows the liquid to pass through the upper layer to the absorbent material.

### BRIEF DESCRIPTION OF THE DRAWINGS

The teachings of the present disclosure can be readily understood by considering the following detailed description in conjunction with the accompanying drawings, in which:

FIG. 1 illustrates a top view of an exemplary hydratable temperature control product according to one embodiment of the present disclosure;

FIGS. 2A & 2B illustrate cross-sectional views, taken along the line 2-2 of FIG. 1, showing a hydratable temperature control product according to one embodiment of the present disclosure in unhydrated (FIG. 2A) and hydrated (FIG. 2B) states;

FIG. 3 illustrates a cross-sectional view showing a portion of an apertured outer layer of a hydratable temperature control product in greater detail according to one embodiment of the present disclosure;

FIGS. 4A & 4B illustrate cross-sectional views showing a hydratable temperature control product according to one embodiment of the present disclosure in unhydrated (FIG. 4A) and hydrated (FIG. 4B) states, wherein two outer layers are provided;

FIGS. 5A & 5B illustrate cross-sectional views showing another hydratable temperature control product according to one embodiment of the present disclosure in unhydrated (FIG. 5A) and hydrated (FIG. 5B) states, wherein two apertured outer layers are provided; and

FIG. 6 illustrates a flowchart of an exemplary method for manufacturing a hydratable temperature control product according to one embodiment of the present disclosure.

To facilitate understanding, identical reference numerals have been used, where possible, to designate identical elements that are common to the figures.

### DETAILED DESCRIPTION

Embodiments of the present disclosure relate to hydratable temperature control products having an apertured outer layer. In one embodiment, the product includes hydratable packets formed from an impervious bottom layer, a permeable upper layer, an absorbent material (e.g., an absorbent powder) positioned between the impervious bottom layer and the permeable upper layer, and an apertured outer layer positioned over the permeable upper layer. In one embodiment, the apetured outer layer includes a three-dimensional structure formed by, for example, cone-shaped recesses having apertures at the bottoms thereof such that only the bottoms of the cone-shaped recesses contact the permeable upper layer and suspend the remainder of the outer layer above the permeable upper layer, thereby minimizing contact between the permeable upper layer and the apertured outer layer. The packets can be hydrated by wetting the apertured outer layer, such that water seeps through both the apertured outer layer and the permeable upper layer, and is absorbed by the absorbent powder (or other absorbent material) to form a hydrogel (or other suitable material). The absorbent powder expands in volume when hydrated, partially closing the cone-shaped recesses in the apertured outer layer such that the cone-shaped recesses act as valves and reduce seepage of the hydrogel from the packet. The packets can then be frozen, or heated, and used as desired. The apertured outer layer limits direct contact between the hydrogel and the exterior of the packets when the packets are handled by a user. The apertured outer layer also limits contact between the hydrogel and the atmosphere, thereby inhibiting condensation from forming on the outer layer. In one embodiment, a second apertured outer layer is also provided on top of the apertured outer layer.

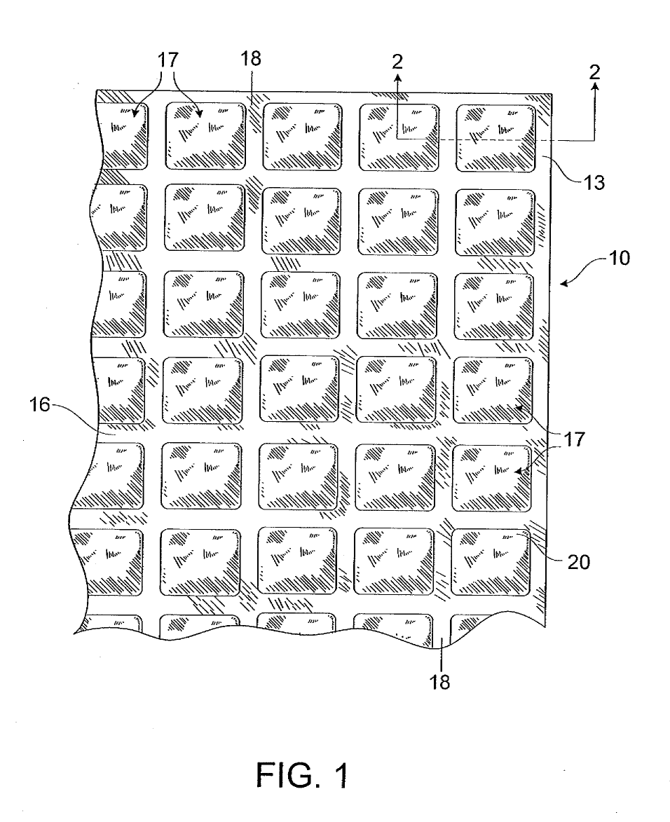

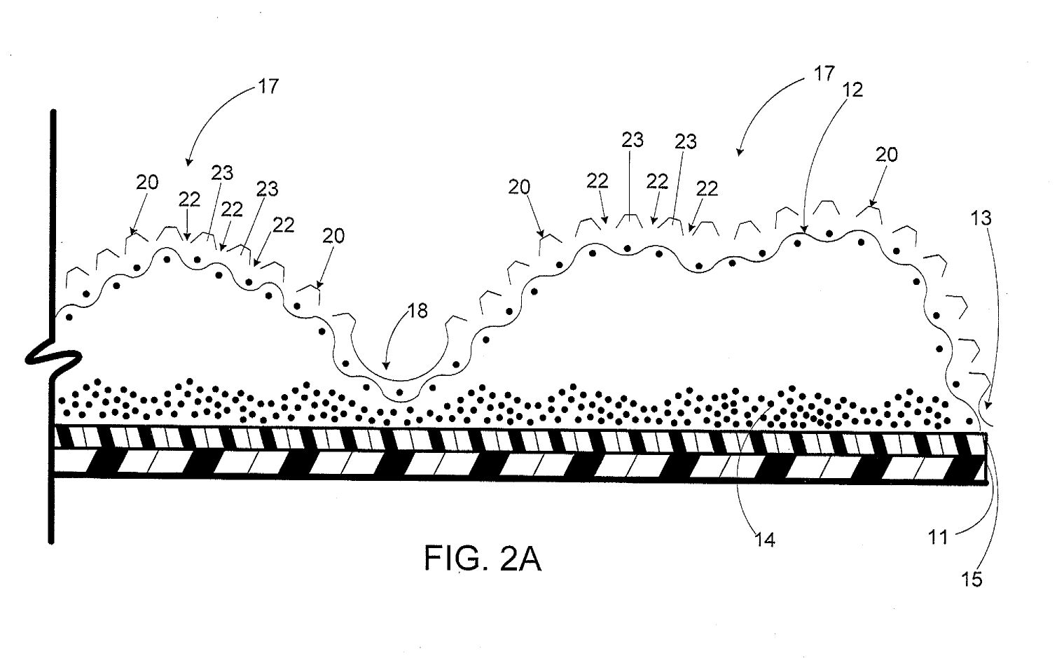

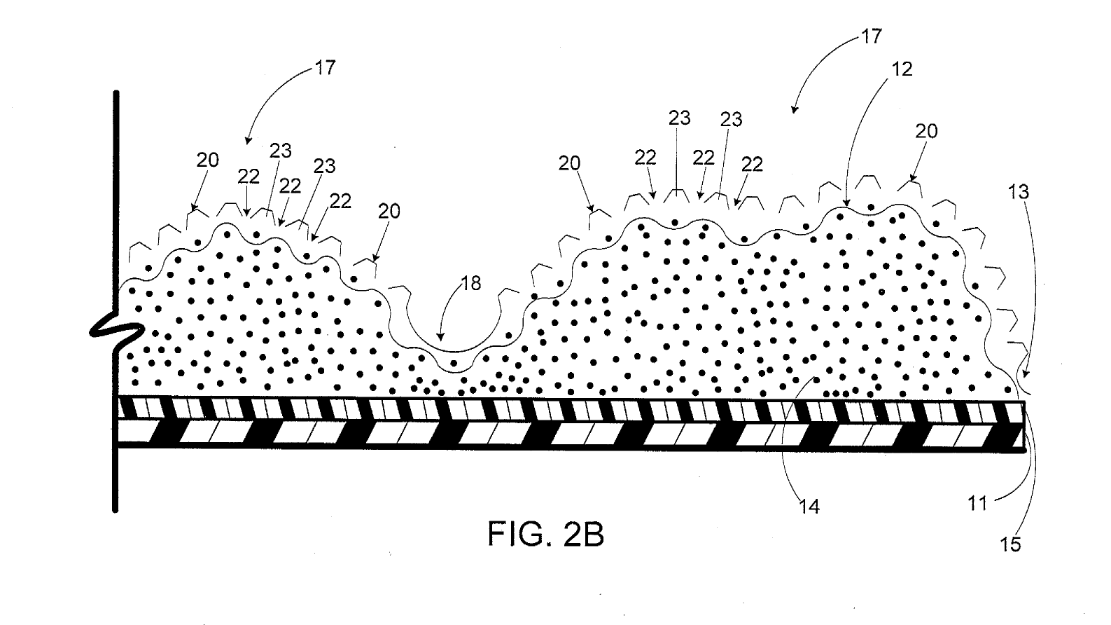

FIG. 1 is a top view of a hydratable temperature control product according to one embodiment of the present disclosure. The hydratable temperature control product comprises a sheet 10, having a plurality of packets 17. The packets 17 are defined by horizontally- and vertically-extending flat valleys 16 and 18. An apertured outer layer 20, discussed in greater detail below, is provided on one side of the sheet 10. An impervious bottom layer 11 (see FIGS. 2A-2B) is provided on the opposite side of the sheet 10, and is joined to the apertured outer layer 20 at the flat valleys 16 and 18 as well as around a peripheral edge 13 of the sheet 10. Inside each of the packets 17 is an absorbent material. In one embodiment, the absorbent material comprises a highly absorbent polymeric material (discussed in greater detail below) which can absorb water and/or other liquids/solutions to form a hydrogel (or other suitable substance) that can be cooled or heated. In one embodiment, a permeable upper layer comprising a porous sheet material permeable to water and/or other liquids/solutions is positioned between the absorbent material and the apertured outer layer 20. Once heated or cooled, the sheet 10, or any one (or more) of the packets 17, can be used to control the temperature of one or more items, such as food, beverages, human or animal tissue, etc. Of course, in various embodiments the size and shape of the sheet 10 can be altered as desired, and any desired number of packets 17 can be provided.

FIGS. 2A-2B are cross-sectional views, taken along the line 2-2 of FIG. 1, showing the hydratable temperature control product in unhydrated (FIG. 2A) and hydrated (FIG. 2B) states. In one embodiment, the packets 17 are formed from an impervious bottom layer 11, such as a plastic sheet material (e.g., a polyester film), a porous upper layer 12 which is permeable to water (e.g., a non-woven polypropylene sheet, or a similar sheet comprising a polypropylene-polyethylene mixture), and the apertured outer layer 20. In one embodiment, the layers 11, 12, and 20 are joined at the flat valleys 16 and 18 and the peripheral edge 13 by way of a tacky adhesive layer 15 (e.g., ethylene-methyl-acrylate, or other suitable material). In another embodiment, the layers 11, 12, and 20 could be joined in any other suitable way, e.g., by ultrasonic welding, a heat-activated glue, such as a thin layer of polyethylene integrated with a polyester sheet to form the bottom layer, etc. In one embodiment, an absorbent material (e.g., an absorbent powder 14) is positioned between the bottom layer 11 and the upper layer 12. The powder 14 could be formed from a superabsorbent polymeric material of a multiply-cross-linked polymer (e.g., double-cross-linked sodium polyacrylate polymer), or other suitable material such as an absorbent foam. In one embodiment, the layers 11 and 12, as well as the adhesive layer 15 and the powder 14, are formed from the materials disclosed in U.S. Pat. No. 6,269,654, issued Aug. 7, 2001, to Murray, et al., the entire disclosure of which is expressly incorporated herein by reference.

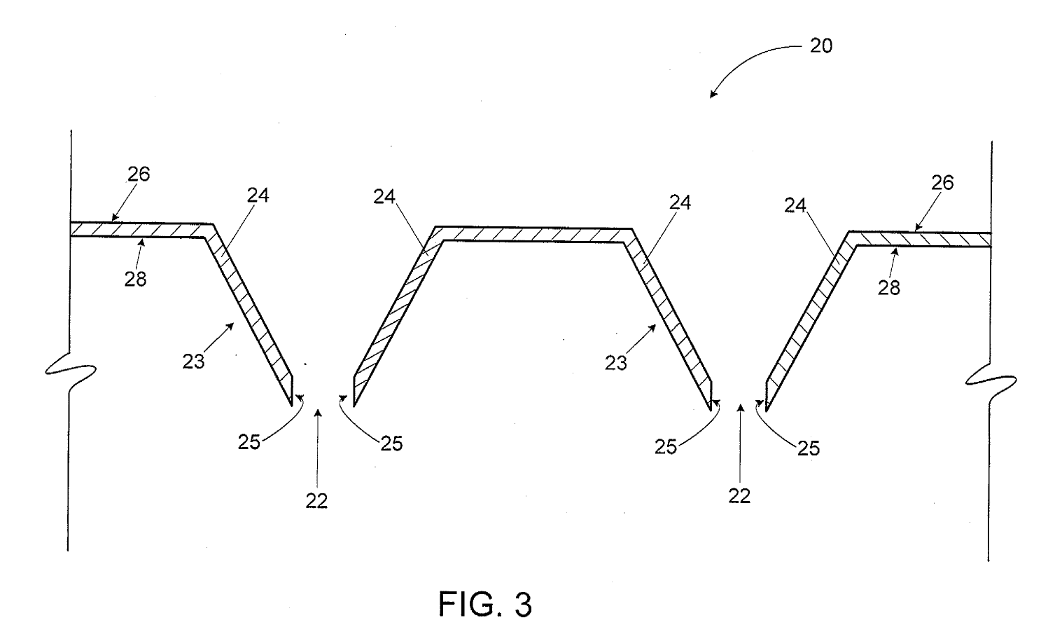

In one embodiment, the apertured outer layer 20 is formed from a film, such as a three-dimensional non-woven sheet. In still another embodiment, the apertured outer layer 20 comprises a substantially flat, or two-dimensional sheet. In one embodiment, the layer 20 includes apertures 22 which allow water or other liquids/solutions to pass through the apertured outer layer 20 to an exterior surface of the upper layer 12 when the packets 17 (e.g., the absorbent material/powder 14 in the packets 17) are hydrated. As can be seen in FIGS. 2A-2B and 3, the apertures 22 can be formed at the bottom of cone-shaped recesses 23 which extend down from the surface of layer 20 and narrow to an open end. The apertures 22 in apertured outer layer 20 direct water toward the interior of packet 17. Water passes through the upper layer 12, and is absorbed by the powder 14 (or other absorbent material) to form a hydrogel (or other suitable substance). It is noted that the apertured outer layer 20 need not be limited to a single side of the sheet 10, and in fact, the apertured outer layer 20 could be provided on both sides of the sheet 10. Moreover, the impervious bottom layer 11 could be substituted with one or more of the layers 12 and 20, if desired. Further, additional or multiple apertured outer layers can be used in accordance with various embodiments, as described below.

As shown in FIG. 2B, in one embodiment, once hydrated the powder 14 forms a hydrogel 14′ which expands and fills the packets 17. As the hydrogel 14′ forms, it stretches the layers 12 and 20. Advantageously, the apertures 22 formed in the apertured outer layer 20 (discussed in greater detail below in connection with FIG. 3) are partially closed when stretched by the hydrated powder, or hydrogel 14′. In other words, each of the apertures 22 acts as a valve that is “open” when the powder 14 is unhydrated and “closed” when in hydrogel 14′ form. This limits the potential for the hydrogel 14′ to exude from or seep out of packet 17 and serves to increase user comfort by reducing any “slippery” feel resulting from the exude of the hydrogel. The cone-shaped recesses 23 forming the three dimensional structure of apertured outer layer 20 also suspend a portion of the apertured outer layer 20 above the upper layer 12, thereby limiting contact between apertured outer layer 20 and upper layer 12 to minimize the formation of condensation on the outer layer 20 after the packets 17 have been frozen.

FIG. 3 is a cross-sectional view showing one embodiment of a portion of an apertured outer layer 20 of a hydratable temperature control product in greater detail. As can be seen, the apertured outer layer 20 includes cone-shaped recesses 23 and apertures 22 defined by angled walls 24 which terminate in bottom ends 25. In one embodiment, the bottom ends 25 of the angled walls 24 contact the upper layer 12 (see FIGS. 2A-2B), and the angled walls 24 partially suspend the apertured outer layer 20 above the upper layer 12. This creates a space between the inner surface 28 of the apertured outer layer 20 and the upper layer 12, which inhibits the formation of condensation on the outer surface 26 of the apertured outer layer 20. Further, the spacing of the apertured outer layer 20 from the upper layer 12 by the cone-shaped recesses 23 minimizes the likelihood of any hydrogel and/or other exudates from seeping out of the packet. Although in several embodiments the recesses 23 are depicted and described herein as cone-shaped, it is noted that in various other and further embodiments, the recesses 23 could have any desired shape, e.g., they could be hexagonal, octagonal, pyramidal, etc.

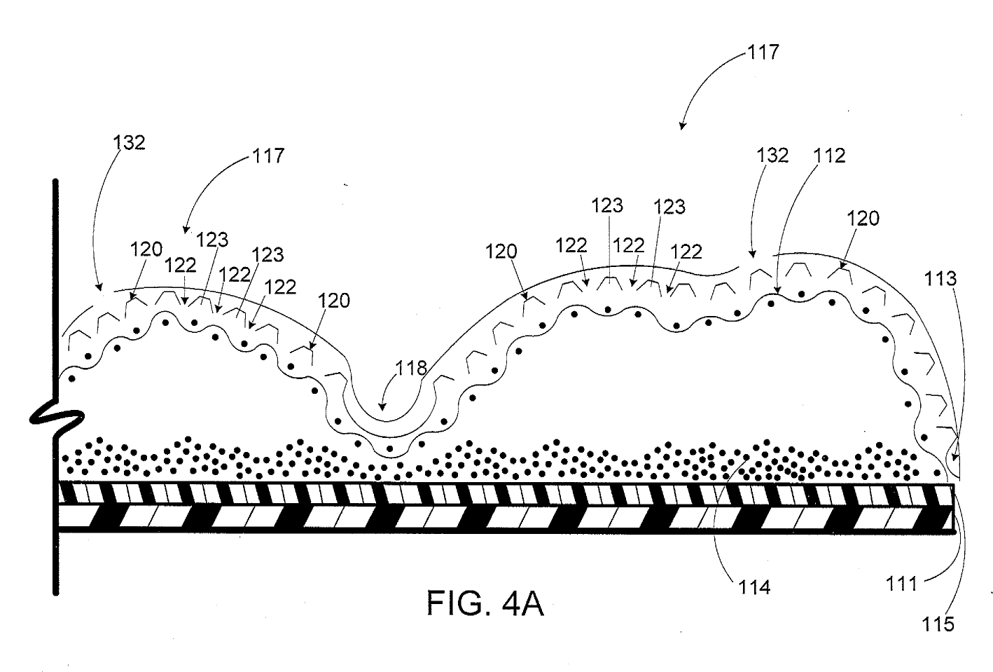

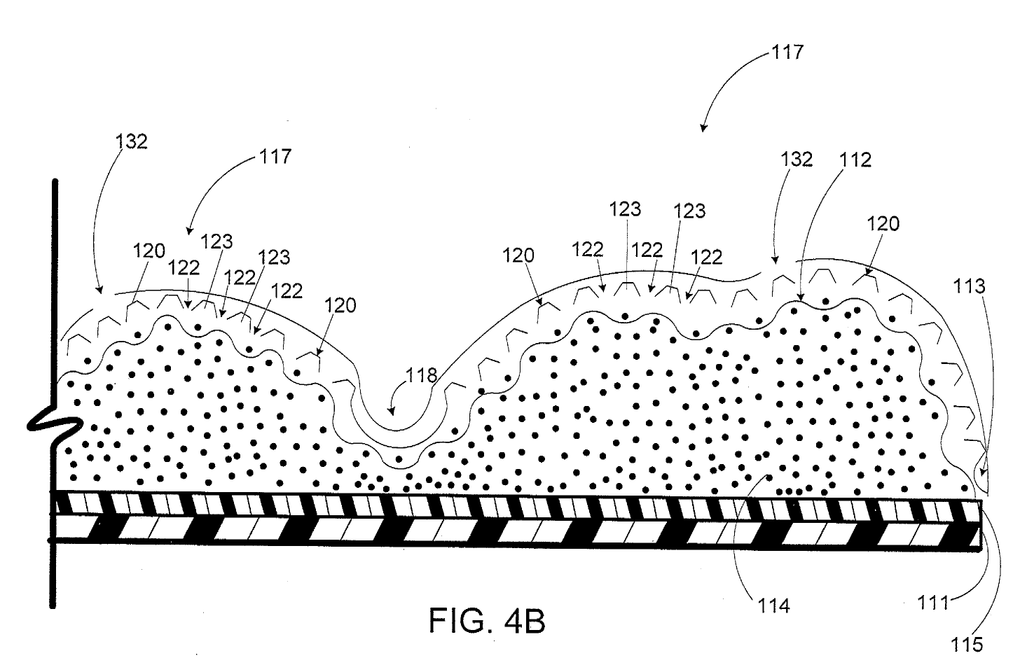

FIGS. 4A-4B illustrate cross-sectional views showing another embodiment of a hydratable temperature control product in unhydrated (FIG. 4A) and hydrated (FIG. 4B) states, wherein a second outer layer 130 is provided. Elements present in the embodiments discussed above in connection FIGS. 1-3 which are also identified in this embodiment are indicated by reference numerals incremented by 100. The second outer layer 130 is positioned over the first apertured outer layer 120, and is joined to the sheet at horizontal and vertical valleys 118 and peripheral edge 113 (e.g., by the adhesive 115 or in any other suitable fashion, e.g., by ultrasonic welding, heat activated glue, such as a polyethylene layer integrated within the bottom layer, and the like). In one embodiment, the second outer layer 130 comprises an apertured sheet having the same or similar features to those provided in the first apertured outer layer 120. For example, the second outer layer 130 may comprise a generally impermeable film made of plastic or other suitable material that includes at least one aperture 132 which allows water and/or other liquids/solutions to pass through the second apertured outer layer 130, and thereafter through the layers 120 and 112 where it is absorbed by the powder 114 (or other absorbent material) to create a hydrogel 114′ (or other suitable substance). In one embodiment, each of the apertures 132 may be formed at the end of a recess (e.g., a cone-shaped recess). The second apertured outer layer 130 provides additional protection against contact with the hydrogel 114′ and/or exudates therefrom and inhibits the formation of condensation when the packets 117 are frozen. In one embodiment, a smaller number of apertures 132 (and therefore a smaller number of associated recesses) in the second apertured outer layer 130 provides greater protection against seepage, but can result in the powder 114 taking longer to hydrate. It is noted that in various embodiments, more than one aperture 132 per packet 117 could be provided in the second apertured outer layer 130, and such apertures 132 could be positioned at any desired spacing (e.g., one aperture per square inch).

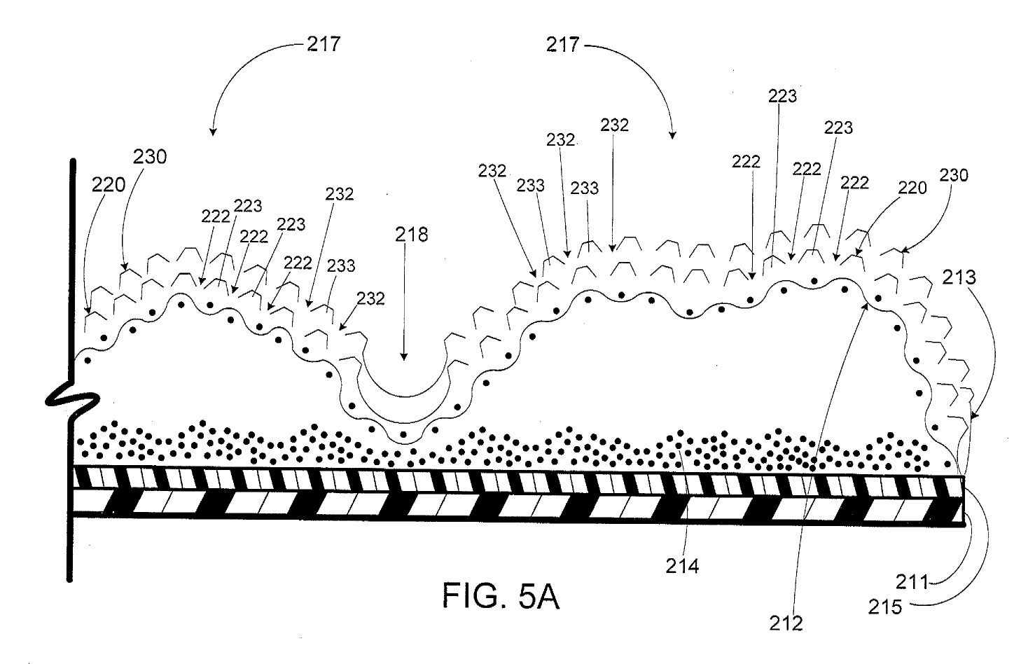

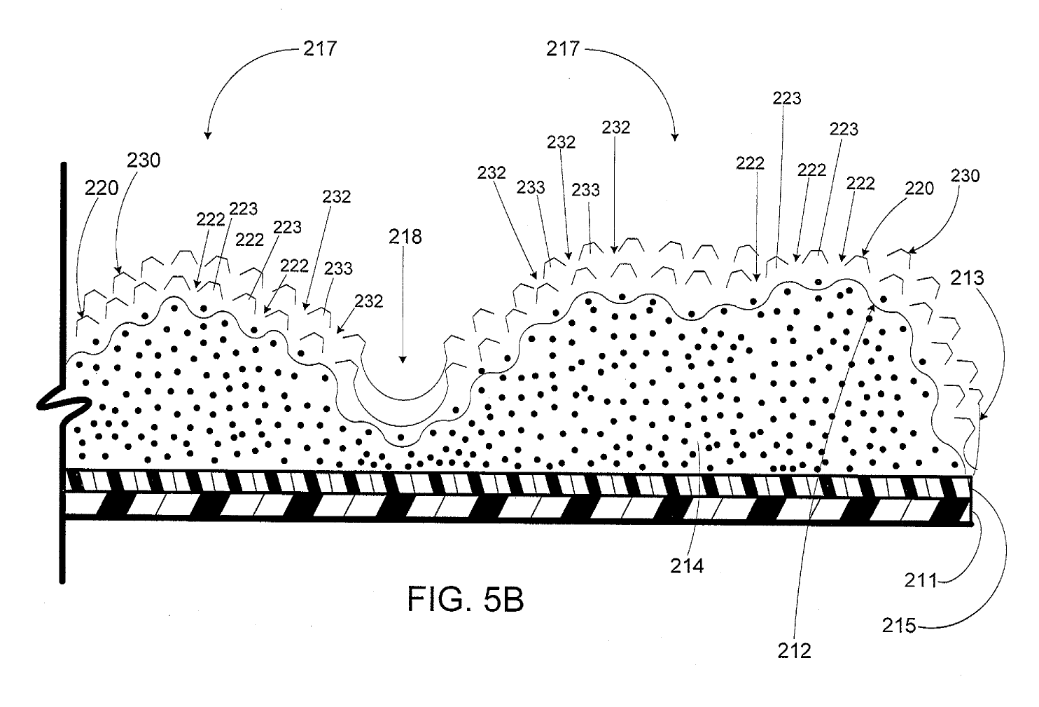

FIGS. 5A-5B are cross-sectional views showing another embodiment of a hydratable temperature control product of the present disclosure, wherein two apertured outer layers (first apertured outer layer 220 and second apertured outer layer 230) are provided. The layers 220 and 230 are similar in construction to the layers 20 and 120 discussed above in connection with FIGS. 1-4B, and include a plurality of cone-shaped recesses 223, 233 having apertures 222, 232 at the bottoms thereof. The layers 220, 230 are positioned over the upper layer 212, and are joined to the upper layer 212 and bottom layer 211 at horizontal and vertical valleys 218 and along peripheral edge 213 by adhesive layer 215, or in any other suitable fashion, e.g., by ultrasonic welding, a heat-activated glue, such as a layer of polyethylene integrated in the bottom layer, and the like. The packets 217 can be hydrated by wetting the second apertured outer layer 230, whereupon water and/or any other suitable liquid/solution seeps through the layers 230, 220, and 212 and hydrates the powder 214 (or other suitable absorbent material), creating a hydrogel 214′ (or other suitable substance) as shown in FIG. 5B. In one embodiment, the hydrogel 214′ swells, stretching the layers 212, 220, and 230 and partially closing the apertures 222, 232.

In one embodiment, the recesses 223, 233 of the layers 220 and 230 could be conical in shape, or they could have any other desired shape (e.g., triangular-pyramidal, rectangular-pyramidal, square-pyramidal, hexagonal-pyramidal, frusto-conical, etc.). They could also be provided at any desired spacing. The cone-shaped recesses 233 (and apertures 232) of the second apertured outer layer 230 could be smaller than the cone-shaped recesses 223 (and apertures 222) of the first apertured outer layer 220, or they could be of a similar size. In one embodiment, the recesses 223, 233 and associated apertures 222, 232 are positioned offset from each other, and not aligned. Since the second apertured outer layer 230 includes a plurality of apertures 232, the hydrogel 214′ of the packets 217 can be hydrated relatively rapidly and more quickly than a product with a second outer layer having fewer apertures, e.g., as shown in the layer 130 of FIGS. 4A-4B. The layers 220 and 230 provide protection against contact with the hydrogel 214′ when the packets 217 are handled. For example, if the absorbent material 214 is overhydrated, thereby exuding through the upper layer 212 and/or the first apertured outer layer 220, or if the packets(s) 217 are smashed or crushed, the second apertured outer layer 230 provides an added protection against the hydrogel/absorbent material 214′ exuding through to the exterior of the hydratable temperature control product. Also, the second apertured outer layer 230 provides added protection against the formation of condensation on the packets 217 after they have been frozen.

It is noted that various embodiments of a hydratable temperature control product of the present disclosure could be utilized in both commercial and household applications. For example, in commercial applications, numerous sheets of the hydratable temperature control product could be placed into a bin, hydrated in the bin, and once hydrated, they could be stacked and stored in a freezer. In such circumstances, it is permissible for hydration to take some time, and as a result, the outer layer or second outer layer of the hydratable temperature control product could provide a minimal amount of apertures (e.g., the embodiment shown in FIGS. 4A-4B, which includes only a single aperture per packet in the second apertured outer layer, could be sufficient). In household applications, it may be more desirable for the hydratable temperature control product to rapidly hydrate. Accordingly, the first apertured outer layer and/or second apertured outer layer (e.g., first apertured outer layer 220 and second apertured outer layer 230 of FIGS. 5A & 5B) may include a plurality of apertures so as to minimize the amount of time necessary to hydrate the packets, while still trying to minimize exudates which might cause slipperiness of the product when handled. In such circumstances, the embodiments of the hydratable temperature control product shown in FIGS. 1-3 and FIGS. 5A-5B could be utilized. It should be noted that each embodiment of a hydratable temperature control product of the present disclosure could be re-used as desired. For example, a hydratable temperature control product according to the present disclosure may be rehydrated numerous times in the event the absorbent material loses water due to evaporation and/or other factors.

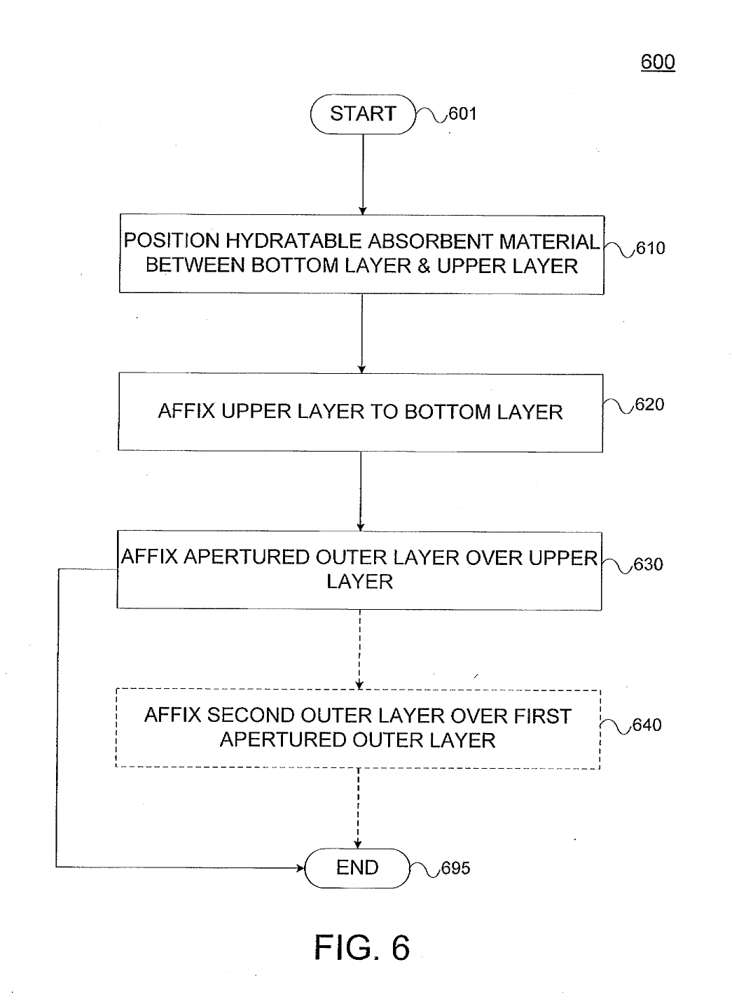

FIG. 6 illustrates an exemplary method for manufacturing a hydratable temperature control product according to one embodiment. The method starts at step 601 and proceeds to step 610. At step 610 a hydratable absorbent material (e.g., an absorbent powder or other suitable substance) is positioned between an upper layer permeable to water and/or other liquids/solutions and a bottom layer. In one embodiment, the absorbent material comprises a powder formed from a superabsorbent polymeric material of a multiply-cross-linked polymer (e.g., double-cross-linked sodium polyacrylate polymer), or other suitable material, such as an absorbent foam. In one embodiment, the bottom layer may comprise an impervious material such as a plastic sheet material (e.g., a polyester film). Similarly, the upper layer may comprise a non-woven polypropylene sheet, or any other suitable material for forming a substantially flat sheet that is permeable to water and/or other liquids/solutions.

The method 600 then proceeds to step 620 where the upper layer is affixed to the bottom layer. In one embodiment, the upper layer is affixed to the bottom layer at flat valleys and peripheral edges by way of a tacky adhesive layer, such as the layer 15 illustrated in FIGS. 2A-2B (e.g., ethylene-methyl-acrylate, or other suitable material). In another embodiment, the apertured outer layer is affixed by ultrasonic welding or another suitable technique. In one embodiment, the affixing of the upper layer to the bottom layer results in the formation of at least one packet containing the hydratable absorbent material. In one embodiment, the affixing the upper layer to the bottom layer results in the creation of a sheet or roll containing multiple packets (e.g., as shown by the packets 17 of FIG. 1).

Following step 620, the method 600 proceeds to step 630 where at least one apertured outer layer is affixed over the upper layer. The apertured outer layer may comprise the apertured outer layer 20 in FIGS. 1-3 or the apertured outer layers 120 or 220 in FIGS. 4A-5B. In one embodiment, the apertured outer layer is affixed over the upper layer via a tacky adhesive layer 15 (e.g., ethylene-methyl-acrylate, or other suitable material). In another embodiment, the apertured outer layer is affixed by ultrasonic welding, heat activated glue, an additional layer of polyethylene, or another suitable technique.

In one embodiment, following step 630, the method 600 proceeds to step 695, where the method ends. By way of the method 600 as described, a hydratable temperature control product may be formed comprising the bottom layer, the hydratable absorbent material, the upper layer, the apertured outer layer, and adhesives, if any.

In another embodiment, following step 630, the method 600 proceeds to optional step 640 where a second outer layer is affixed over the first apertured outer layer (e.g., the apertured outer layer affixed at step 630). In one embodiment, the second outer layer may comprise the second apertured outer layer 130 in FIGS. 4A-4B or the second apertured outer later 230 in FIGS. 5A-5B. Following step 640, the method 600 proceeds to step 695 where the method ends.

While various embodiments have been described above, it should be understood that they have been presented by way of example only, and not limitation. For example, although an exemplary method 600 has been described above as a particular series of steps, it should be understood that embodiments of the present disclosure are not so limited. Namely, methods according to the present disclosure may perform one or more the steps of the method 600 in a different order than that which is described above, may include additional steps or even omit certain steps. Thus, the breadth and scope of embodiments of the present disclosure are not be limited by any of the above-described exemplary embodiments, but should be defined only in accordance with the following claims and their equivalents.

What is claimed is:

1. An apparatus for providing temperature control comprising:
a bottom layer;
an upper layer permeable to liquid;
a hydratable absorbent material positioned between the bottom layer and the upper layer; and
an outer layer positioned over the upper layer, the outer layer having at least one aperture, wherein the at least one aperture is configured to pass a liquid from an exterior surface of the outer layer to the upper layer.

2. The apparatus of claim 1, wherein the outer layer comprises a plurality of apertures.

3. The apparatus of claim 2, wherein the outer layer comprises a plurality of recesses, each of the plurality of recesses including one of the plurality of apertures.

4. The apparatus of claim 3, wherein each of the plurality of recesses is a substantially cone shaped recess.

5. The apparatus of claim 1, wherein the bottom layer, the upper layer, the outer layer and the hydratable absorbent material are formed into a layered sheet having at least one packet.

6. An apparatus for providing temperature control comprising:
a bottom layer;
an upper layer permeable to liquid;
a hydratable absorbent material positioned between the bottom layer and the upper layer;
a first outer layer positioned over the upper layer, the first outer layer having at least one aperture, wherein the at least one aperture is configured to pass a liquid from an exterior surface of the first outer layer to the upper layer; and
a second outer layer positioned over the first outer layer.

7. The apparatus of claim 6, wherein the second outer layer comprises at least one aperture, wherein the at least one aperture in the second outer layer is configured to pass a liquid from an exterior surface of the second outer layer to the first outer layer.

8. The apparatus of claim 7, wherein the at least one aperture of the second outer layer is offset from the at least one aperture of the first outer layer.

9. The apparatus of claim 7, wherein the second outer layer comprises a plurality of apertures.

10. The apparatus of claim 9, wherein a number of apertures included in the second outer layer is less than a number of apertures included in the first outer layer.

11. A method for manufacturing a temperature control product having a bottom layer, an upper layer permeable to liquid, a hydratable absorbent material and a first outer layer, the method comprising:
positioning the hydratable absorbent material between the bottom layer and the upper layer;
affixing the upper layer to the bottom layer; and
affixing the first outer layer over the upper layer, the first outer layer having at least one aperture for passing a liquid from an exterior surface of the first outer layer to the upper layer, thereby allowing the liquid to pass through the upper layer to the absorbent material.

12. The method of claim 11, wherein the affixing the upper layer to the bottom layer results in a formation of at least one packet, the at least one packet containing the hydratable absorbent material.

13. The method of claim 11, wherein the first outer layer comprises a plurality of apertures.

14. The method of claim 13, wherein the first outer layer further comprises a plurality of recesses, each of the plurality of recesses including one of the plurality of apertures.

15. The method of claim 11, further comprising:
forming the bottom layer, the upper layer, the first outer layer and the hydratable absorbent material into a layered sheet having at least one packet.

16. The method of claim 11, further comprising:
affixing a second outer layer positioned over the first outer layer.

17. The method of claim 16, wherein the second outer layer comprises at least one aperture, wherein the at least one aperture in the second outer layer is configured to pass a liquid from an exterior surface of the second outer layer to the first outer layer.

18. The method of claim 17, wherein the second outer later is affixed over the first outer layer such that the at least one aperture of the second outer layer is offset from the at least one aperture of the first outer layer.

19. The method of claim 16, wherein the second outer layer comprises a plurality of apertures.

20. The method of claim 19, wherein a number of apertures included in the second outer layer is less than a number of apertures included in the first outer layer.
